(19) United States
(12) Patent Application Publication
(10) Pub. No.: US 2020/0062622 A1
(43) Pub. Date: Feb. 27, 2020

(54) AN AIR TREATMENT SYSTEM

(71) Applicant: PLASMA AIR INTERNATIONAL, INC, Stamford, CT (US)

(72) Inventors: Charles Linley, Easton, CT (US); Lawrence T. Sunshine, Rye Brook, NY (US)

(73) Assignee: PLASMA AIR INTERNATIONAL, INC, Stamford, CT (US)

(21) Appl. No.: 16/547,202

(22) Filed: Aug. 21, 2019

Related U.S. Application Data
(60) Provisional application No. 62/720,513, filed on Aug. 21, 2018.

(51) Int. Cl. C02F 1/58; C02F 3/00; C02F 1/42

(52) U.S. Cl. CPC C02F 1/583; B01D 53/52; C02F 1/42; C02F 3/006

(57) ABSTRACT

Systems for treating air in a wet well are provided. For example, a system comprises a housing with inlet and outlet openings, where the inlet opening is on the bottom wall. The inlet opening is covered by a screen or has a filter installed within or adjacent to the opening. The system further comprising an ionization device configured to generate bi-polar ions within a compartment of the housing and a fan disposed within the compartment. The fan has an air outlet mounted to the wall of a body of the housing orthogonal to the bottom wall, where the air outlet of the fan is aligned with the outlet opening in the wall. Power is supplied from an external power source. The power is selectively connected to at least the ionization device based on a criterion.

### CROSS-REFERENCE TO RELATED APPLICATIONS

This present application claims benefit of U.S. Provisional Application No. 62/720,513, filed on Aug. 21, 2018, all of the contents of which are incorporated herein by reference.

### FIELD OF THE DISCLOSURE

This disclosure relates to air treatment. More specifically, this disclosure relates to systems and methods for treating air such as within a wet well.

### BACKGROUND

A wet well is typically located on the sump side of a pump station. A wet well contains sewage or water. The water may be storm water, sanitary water or a combination. The waste and or storm water flows downhill via gravity in vented flow paths and then is pumped uphill at a pump station so that it can flow downhill to the next pump station or treatment facility. As a result of containing sewage, the wet well has hydrogen sulfide. The hydrogen sulfide provides a foul odor. Additionally, as the sewage and water are pumped from the wet well, hydrogen sulfide develops throughout the system.

### SUMMARY

Accordingly, disclosed is an air treatment system for a wet well. The system comprises a water-resistant housing containing, an ionization device and a fan. The housing comprises a door and a body. The body has walls forming a compartment. The door is movable relative to the body to cover the compartment when closed and expose the compartment when open. The body has an inlet opening in a bottom wall. The inlet opening is an air inlet. The inlet opening may be covered by a screen or may have a filter disposed within or adjacent to the air inlet. The body also has an outlet opening in a wall of the body orthogonal to the bottom wall. The outlet opening is an air outlet. The ionization device is configured to generate bi-polar ions. The ionization device is disposed within the compartment in air communication with the inlet opening. The fan is disposed within the compartment. The fan has an air outlet. The air outlet is mounted to the wall of the body orthogonal to the bottom wall. The air outlet of the fan is aligned with the outlet opening in the wall. Power may be supplied from an external power source. The power is selectively connected to at least the ionization device based on a criterion. In some aspects of the disclosure, the system may have a duct collar mounted to the wall of the body orthogonal to the bottom wall and aligned with the outlet opening and the air outlet of the fan. The duct collar may receive an air duct that is couplable to the wet well.

In some aspects, the system may comprise a backdraft damper in-line with the air duct. The damper may be positioned between the duct collar and the wet wall. The damper may close to prevent airflow back into the housing when the system is off and open to allow airflow to the wet well.

In some aspects, the damper may be controlled via an actuator.

In some aspects, the system may comprise a door switch. When the door switch indicates that the door is closed, power may be supplied to at least the ionization device, otherwise, the power is isolated from at least the ionization device. Power may also be supplied to the fan or isolated therefrom based on the door switch.

In some aspects, the system may comprise a speed control device for the fan configured to control the speed of the fan. The speed may be controlled based on an air quality sensor.

In some aspects, the system may comprise dry contacts. The dry contacts may be within the ionization device and indicate to a building automation system (BAS) that the ionization device is functioning.

In some aspects, the system may comprise a line voltage thermostat. In some aspects, when an ambient temperature is below a preset temperature threshold, the line voltage thermostat isolates the power from the ionization device and the fan.

In some aspects, the system may comprise a heater and the line voltage thermostat. In some aspects, when the ambient temperature is below the preset temperature threshold, the heater is turned on and when the ambient temperature is above the preset temperature threshold, the heater is shut off.

In some aspects, the system may comprise a solar panel, a rechargeable battery and an inverter. The solar panel may charge (recharge) the rechargeable battery. The rechargeable battery may supply power to the system via the inverter. In some aspects, the inverter may be in a separate housing.

In some aspects, the system may comprise a delay timer which delays the time when the ionization device is turned on with respect to the time that the fan is turned on.

In some aspects, the fan may be a centrifugal fan.

Also disclosed is an apparatus comprising a water-resistant housing containing, an ionization device and a fan. The housing comprises a door and a body. The body has walls forming a compartment. The door is movable relative to the body to cover the compartment when closed and expose the compartment when open. The body has an inlet opening in a bottom wall. The inlet opening is an air inlet. The inlet opening may be covered by a screen or may have a filter disposed within or adjacent to the air inlet. The body also has an outlet opening in a wall of the body orthogonal to the bottom wall. The outlet opening is an air outlet. The ionization device is configured to generate bi-polar ions. The ionization device is disposed within the compartment in air communication with the inlet opening. The fan is disposed within the compartment. The fan has an air outlet. The air outlet is mounted to the wall of the body orthogonal to the bottom wall. The air outlet of the fan is aligned with the outlet opening in the wall. Power may be supplied from an external power source. The power is selectively connected to at least the ionization device based on a criterion.

### BRIEF DESCRIPTION OF DRAWINGS

FIGS. 1 and 2 illustrate an example of an air treatment unit in accordance with aspects of the disclosure, where FIG. 1 shows the housing open, and FIG. 2 shows the housing closed;

FIG. 3 illustrates a view of the air treatment unit showing the air filter in the filter grill in accordance with aspects of the disclosure;

FIG. 4 illustrates an example of a door switch in accordance with aspects of the disclosure;

FIG. 5 illustrates a view of the duct collar and the outlet of a fan in accordance with aspects of the disclosure;

FIG. 6 illustrates a side view of an air treatment unit in accordance with some aspects of the disclosure with an optional access panel;

FIG. 7 illustrates a bottom view of an air treatment unit in accordance with some aspects of the disclosure with the optional access panel;

FIG. 8 illustrates a block diagram of an example of a power path and control in accordance with aspects of the disclosure;

FIG. 9 illustrates a block diagram of an example of a power path and control in accordance with other aspects of the disclosure;

FIG. 10 illustrates a block diagram of an example of a power path and control in accordance with other aspects of the disclosure;

FIG. 11 illustrates a block diagram of an example of a power path and control in accordance with other aspects of the disclosure;

FIG. 12 illustrates a block diagram of an air treatment system in accordance with aspects of the disclosure;

FIGS. 13 and 14 illustrate examples of an air treatment system attached to a wet well in accordance with aspects of the disclosure;

FIG. 15 illustrates another example of an air treatment system attached to a wet well in accordance with aspects of the disclosure. FIG. 15 also shows a bottom view of the air treatment unit shown screened air inlet;

FIG. 16 illustrates another example of an air treatment system attached to a wet wall having a backdraft damper in-line in the duct between an air treatment unit and the wet well, in accordance with aspects of the disclosure;

FIG. 17 illustrates another example of an air treatment system attached to a wet wall having a backdraft damper in-line in the duct between an air treatment unit and the wet well, in accordance with aspects of the disclosure, where the damper is controlled via an actuator;

FIG. 18 illustrates a diagram of an example of an air treatment unit in accordance with some aspects of the disclosure;

FIG. 19 illustrates a block diagram of an example of a power path and control in accordance with other aspects of the disclosure; and

FIG. 20 illustrates another example of an air treatment unit in accordance with aspects of the disclosure, where FIG. 20 shows the housing open.

### DETAILED DESCRIPTION

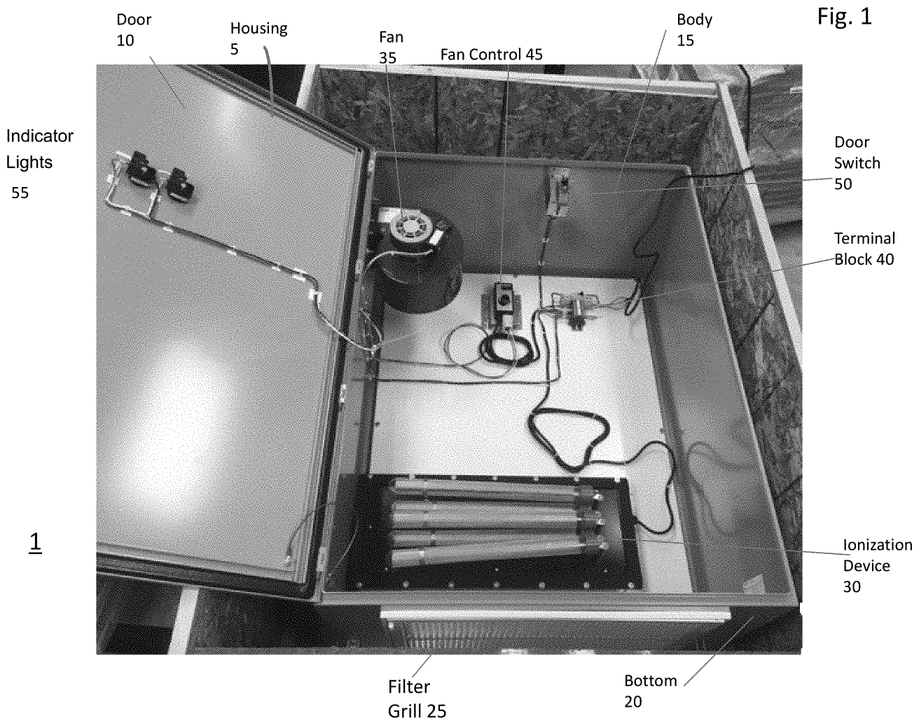

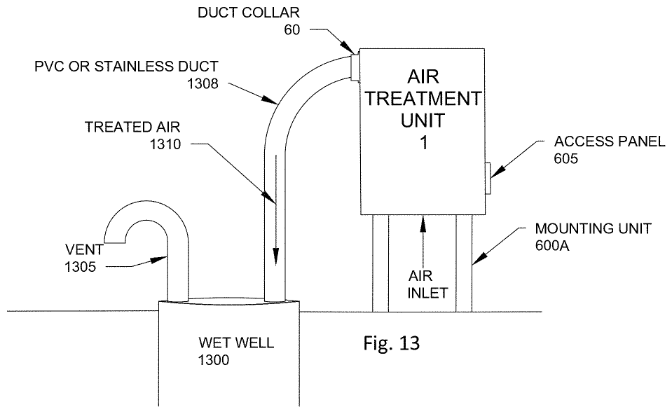

FIG. 1 depicts an example of an air treatment unit 1. The air treatment unit 1 may be used to treat air. The air treatment unit 1 may be a component of an air treatment system or may be the air treatment system. For example, the air treatment unit 1 may be installed to treat air within a wet well. Examples of treatment systems are shown in FIGS. 13-17

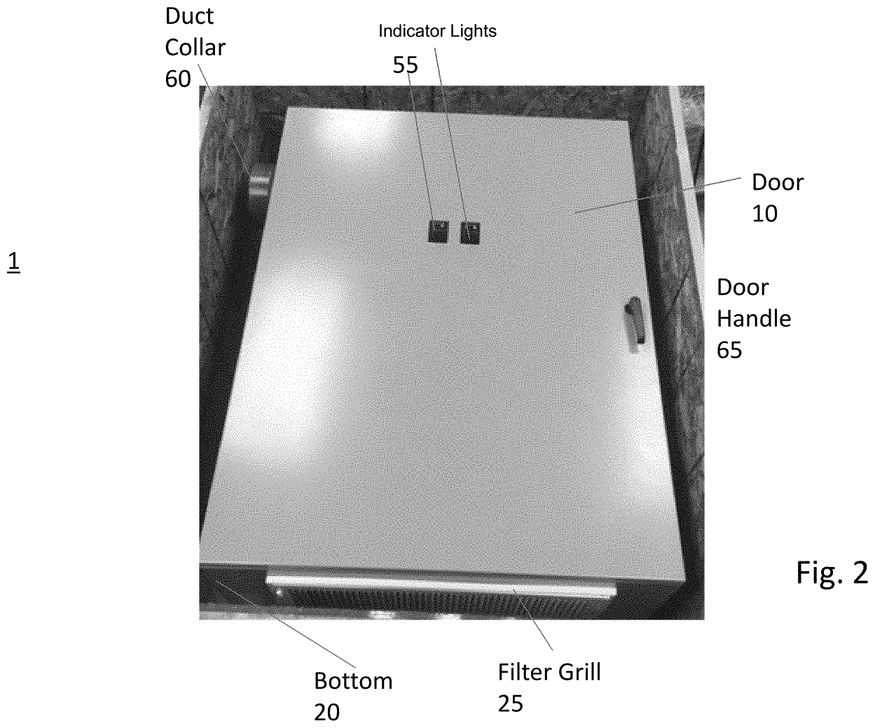

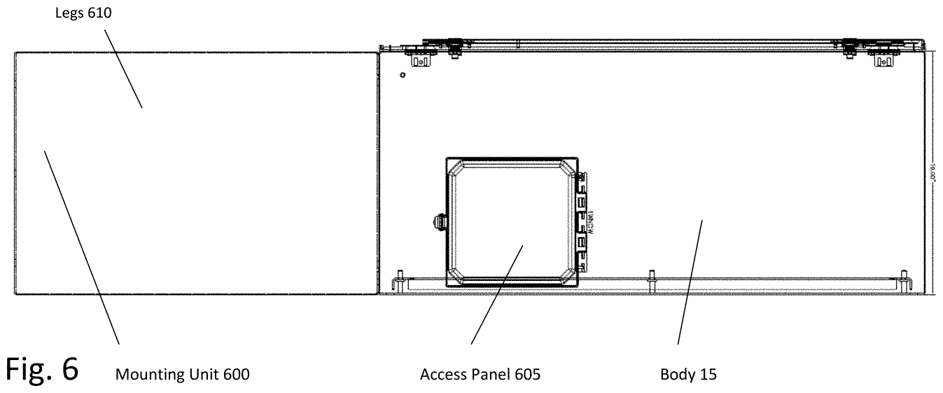

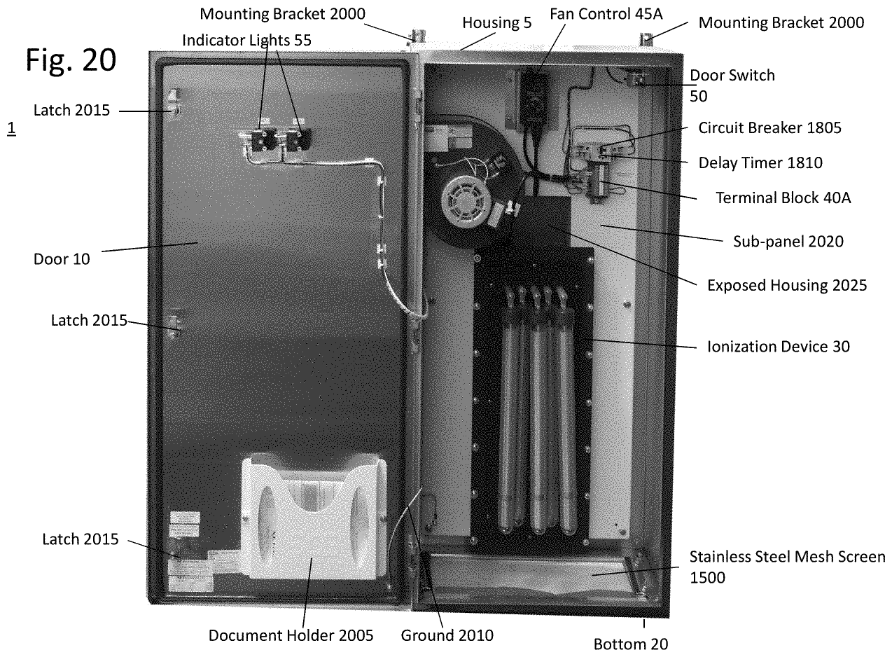

The air treatment unit 1 has a housing 5. The housing 5 has a door 10 and a body 15. Given the likely locations of the air treatment unit 1, in an aspect of the disclosure, the housing 5 is made to be water-resistant and non-corrosive. For example, a National Electrical Manufacturers Association (NEMA) type 4X electrical box may be used. The NEMA box may be constructed of stainless steel. The door 10 may pivotally be attached to the body 15 to open and close. The hinges are on one side. A door handle 65 (shown in FIG. 2) is on the opposite side. The door 10 has latches to mate with the body 15 when closed. The latches are shown in FIG. 6. The door may optionally have a door handle 65. The door handle 65 may be mechanically coupled to the latches 2015. In other aspects, instead of a door handle 65, other structures may be used to open the latches 2015. The latches 2015 may be turned to open (see FIG. 20).

In another aspect of the disclosure, the door 10 may be separate from the body and attached with channels or fasteners.

The body 15 has walls. The walls form a components compartment. The door 10 may be mounted to one of the walls. One of the walls is a bottom 20 in operation orientation. Top, bottom, front and back referenced herein is with reference to operation orientation.

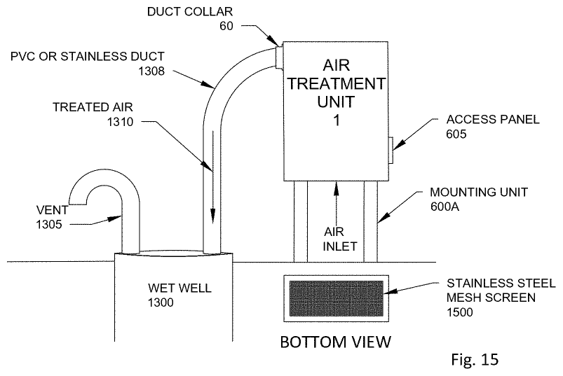

The bottom 20 may have at least one opening. The opening is an air inlet. The opening(s) is on the bottom such that water (weather related such as snow, rain or sleet) is difficult to enter via the opening(s). In an aspect of the disclosure, a mesh screen may cover the air inlet. For example, a mesh screen 1500 may be made of stainless steel. As shown in FIG. 15-17 (bottom view) and FIG. 20, the mesh screen 1500 covers at least a portion of the air inlet. FIGS. 15-17 and 20 illustrate a single mesh screen 1500 covering the air inlet. However, multiple screens may be used where the inlet is two or more openings.

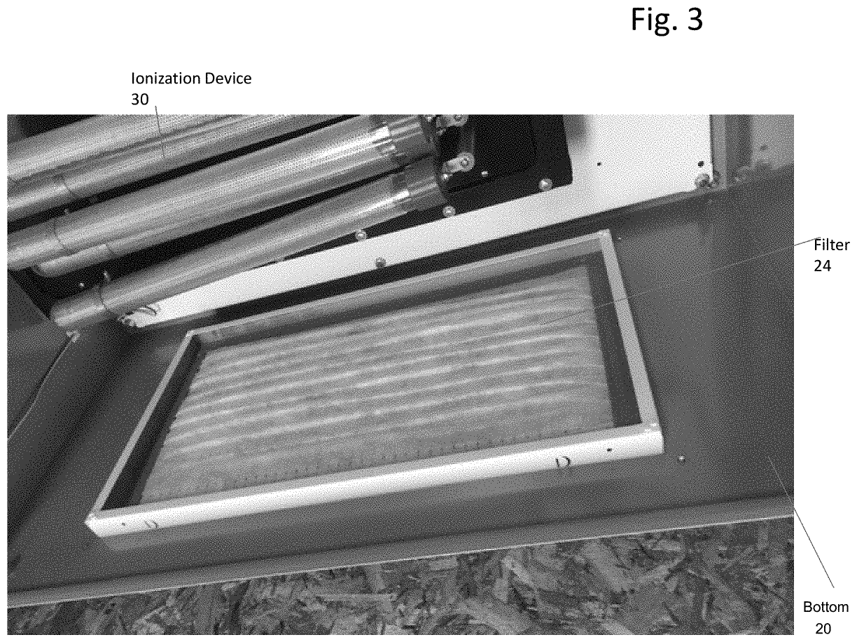

In other aspects, the at least one opening may have a filter system as shown in FIG. 1. For example, a filter grill 25 may be installed in the opening(s). The filter 24 is an air filter. The filter 24 and filter grill 25 is one example of a filter unit. The filter grill 25 may be detached from the housing 5 from the outside to change the filter 24 as needed. FIG. 3 shows the filter 24 (viewed from inside the housing 5). In other aspects of the disclosure, other filter units (systems) may be used instead of a filter grill 25. For example, a filter having a screen may be used. In this aspect, the louvers may be internal to the housing. The filter may be changed from the inside of the housing. The type of filter unit (system) used in the unit 1 may be determined by the type of mounting unit 600.

The air treatment unit 1 also comprises an air treatment device 30A. In the example depicted in FIG. 1, the air treatment device 30A is an ionization device 30. The ionization device 30 may be a bi-polar ion generation device capable of producing ions at various intensities. Also as depicted, the ionization device 30 has a plurality of ionization tubes (tube style). However, other types of ionization devices may be used such as an ionizing needle, or an ionizing brush at various intensities. The ionization device 30 may be a device capable of producing positive ions, negative ions or a combination of positive ions and negative ions. The ionization device 30 may include ionizing needle elements, which are rod shaped and come to a point at one end. Alternatively, the ionization device 30 may include ionizing brushes, which can contain a plurality of bristles or fibers formed of a conductive material. Each of the ionizing needle, ionizing brush and ionizing tube can include components formed of a material sufficient to emit ions, such as, for example, a conductive metal, a conductive polymer, a conductive semi-fluid and a carbon material.

In other aspects of the disclosure, the air treatment device 30A may be a UV light emitter or an ozone emitter. FIG. 1 shows one ionization device 30 having a plurality of tubes, however, multiple ionization devices 30 may be used. In an aspect of the disclosure, different types of air treatment devices 30A may be incorporated into the air treatment unit 1. For example, an ionization device 30 may be used with an ozone emitter.

In an aspect of the disclosure, the air treatment device 30A, e.g., ionization device 30, is disposed adjacent to the mesh screen or if used, a filter system. The air treatment device is secured to the housing 5 to prevent movement. In some aspects, the ionization elements, such as ionization tubes may be aligned perpendicular to the openings as shown in FIG. 20. This may allow easy access to a control panel of the device. For example, the control panel may be access from the top.

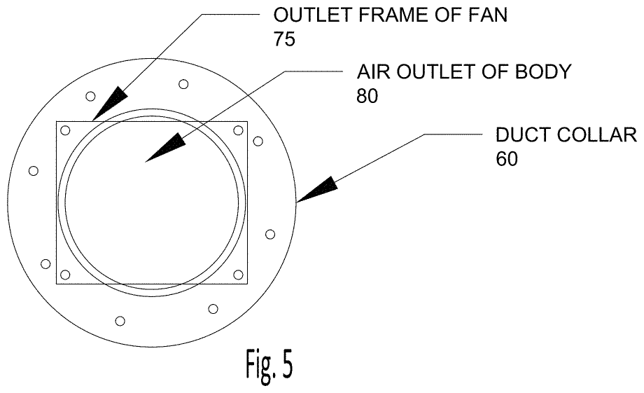

In other aspects, as depicted in FIG. 1, the ionization elements, such as ionization tubes may be aligned parallel to the opening. One of the walls of the body has another opening. This opening serves as an air outlet 80 (shown in FIG. 5). In an aspect of the disclosure, the wall having the another opening (air outlet 80) is perpendicular to the bottom 20. As depicted, the wall having the opening (air outlet 80) is the wall connected to the door 5. However, in other configurations, the opening may be on the opposite wall (or the back wall), or the top depending on the position of the wet well or other target.

A fan 35 is mounted to the wall of the body having the another opening. In an aspect of the disclosure, the fan 35 may be a centrifugal fan. A centrifugal fan has an air inlet in the center and an air outlet. In other aspects of the disclosure, the fan 35 may be an axial fan where the inlet and outlet are axially aligned.

In an aspect of the disclosure, the air outlet of the fan is mounted directly to the wall of the body as shown in FIG. 5. The air outlet of the fan 75 (frame) is attached to the wall. As shown in FIG. 5, the position of the air outlet of the fan 75 also aligns with a duct collar 60. The duct collar 60 extends from the housing 5 as shown in FIG. 2. The duct collar 60 is mounted to the body 15. The duct collar 60 may be also attached to the air outlet of the fan 75 (frame). Thus, the wall of the body is sandwiched by the air outlet of the fan 75 and the duct collar 60. FIG. 5 shows the mounting holes for the connecting means. By directly attaching the air outlet of the fan 75 (frame) to the wall and aligning the same with the duct collar 60, airflow into the wet well or other target is reliably controllable. When an axial fan is used, the rim or frame (outlet side) is mounted to the wall.

The air treatment unit 1 may also comprise a fan control 45. As shown in FIG. 1, the fan control 45 has a dial to change the speed of the fan 35. Other types of fan control 45 may be used. The fan control 45 is coupled to the fan 35 and power. The fan control 45 is mounted to the body 15 to prevent movement. As shown, the fan control 45 is mounted to the back of the body 15.

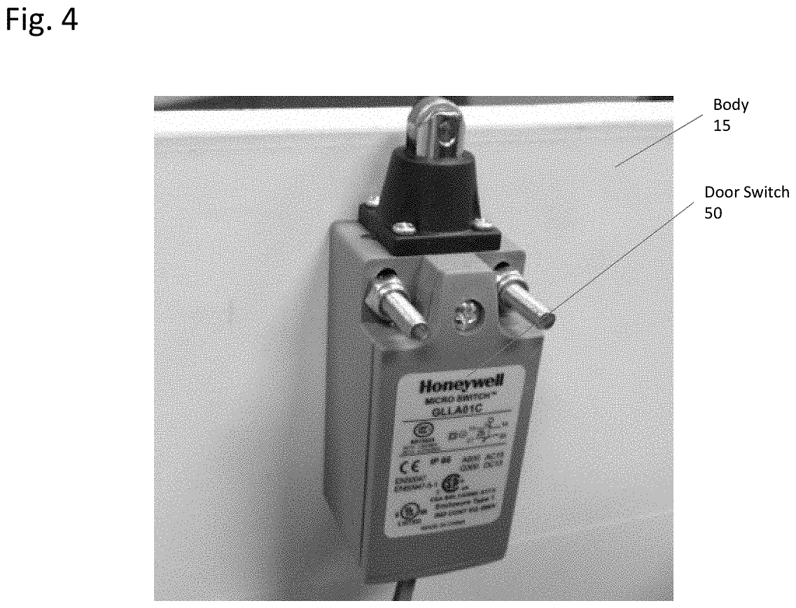

The air treatment unit 1 also comprises at least one control switch. As depicted in FIG. 1 (and in FIG. 4), the control switch includes a door switch 50. The door switch 50 is mounted on a wall of the body 15. As shown in FIG. 4, the door switch 50 has a plunger. The door switch 50 is mounted at a location where the plunger may contact the door 10 when the door 10 is closed. The door switch 50 acts as a power shut off for at least the air treatment device 30A (e.g., ionization device 30). The door switch 50 is electrically coupled to the power and at least the ionization device 30. The door switch 50 opens when the door 10 is open and closes when the door 10 is shut. When the door 10 is open, power is isolated from at least the ionization device 30, whereas, when the door 10 is closed, power may be supplied to the ionization device 30. In some aspects, both the fan 35 and the ionization device 30 are connected to the door switch 50 and when the door is opened, power is isolated from both the fan 35 and the ionization device 30 and when the door is closed, power may be supplied to both the fan 35 and the ionization device 30.

While FIGS. 1 and 4 show the door switch 50 as a mechanical switch with a plunger, other types of switches may be used such as a magnetic connector switch, optical switches and other pressure switches.

The air treatment unit 1 further comprises at least two indicator lights 55. The indicator lights 55 may be mounted on the door 10. The indicator lights 55 are electrically coupled to power. As shown in FIGS. 1 and 2, there are two indicator lights 55 (see also FIG. 20). One of the indicator lights indicates OFF/ON for the power. The other indicator light indicates OFF/ON for the air treatment device 30A (e.g., ionization device 30). The lights from the indicator lights 55 are viewable from the outside of the housing as shown in FIG. 2 (door 10 is closed in FIG. 2). In an aspect of the disclosure, each indicator light 55 is an LED. Below each indicator light is an identifier indicating corresponding item that the light indicator is for. For example, below the indicator light for the power, may read “Main Power”.

The air treatment unit 1 may receive power from an external power supply. In an aspect of the disclosure, the external power supply may be grid power. The air treatment unit 1 may be connected to the grid by wires. The wires are inserted into a wire opening in the housing 5. The wire opening may be weather shielded. In an aspect of the disclosure, the wires may be connected to a terminal block 40 (or terminal block 40A as shown in FIG. 20). Power to the internal electric components is then routed from the terminal block 40 (or terminal block 40A as shown in FIG. 20). For example, the fan control 45, door switch 50, indicator lights 55 and the ionization device 30 may be connected to the terminal block 40 (or terminal block 40A as shown in FIG. 20), where the terminal block 40 (or terminal block 40A as shown in FIG. 20) acts as hub for the power.

In an aspect of the disclosure, the wires and terminal block 40 may be covered and the terminal block 40 may have its own housing (not shown).

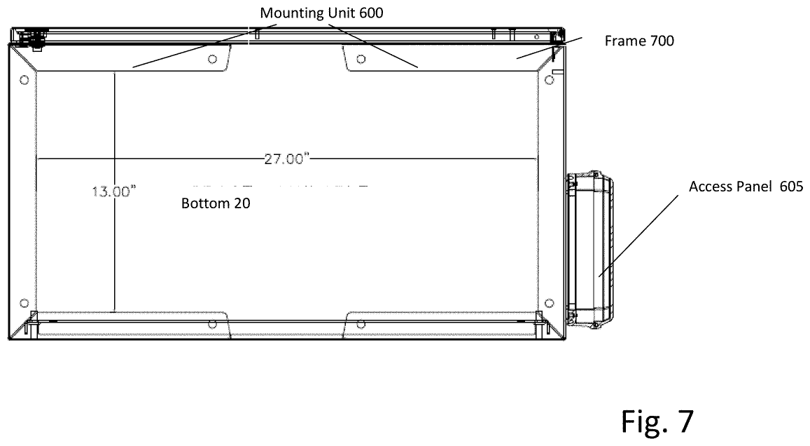

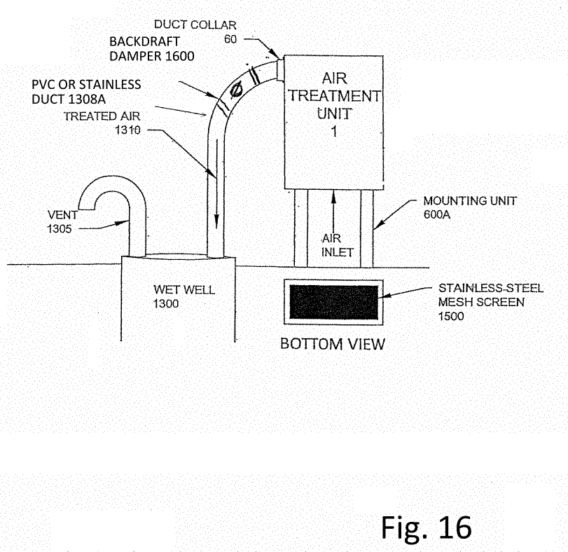

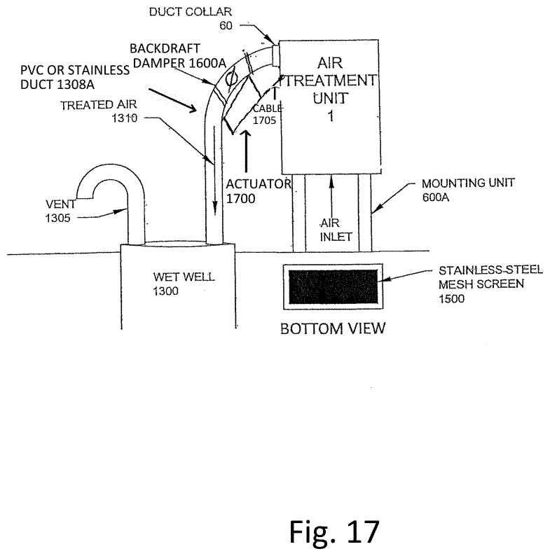

The air treatment unit 1 optionally may have an access panel 605 for accessing the controls for the air treatment device 30A, e.g., ionization device 30 and the speed control. FIGS. 6 and 7 show an example, of an air treatment unit 1 having an access panel 605. FIG. 6 is a right side view. The access panel 605 is mounted to the body 15. The body 15 has an opening. The opening allows access to the controls of the air treatment device and speed control via the access panel 605. The access panel 605 is aligned with the opening. The access panel 605 may have a pivotable window. The pivotable window may be hinged from the top. The window may open from the bottom and pivot upward. In other aspects, the window may be clear to allow viewing of the controls without opening the window. FIGS. 16 and 17 show an air treatment unit 1 without the optional access panel 605.

In an aspect of the disclosure, the access panel 605 also has a door switch. A similar door switch as described above may be used also referenced herein as “50”. The door switch may be positioned to contact the pivotable window when closed.

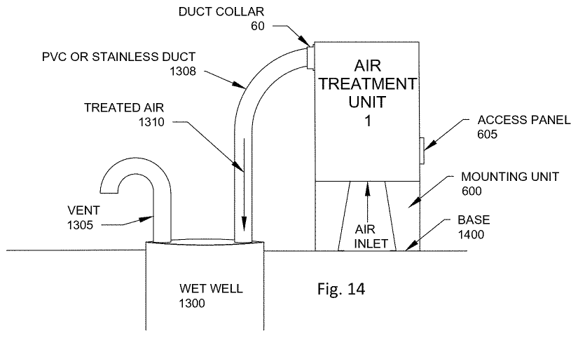

The air treatment unit 1 may have a mounting unit 600. Examples of a mounting unit 600 are shown in FIGS. 6, 7 and 13-17. FIG. 7 is a bottom view. The mounting unit 600 is attachable to the bottom 20 of the air treatment unit 1. The mounting unit 600 may be a pedestal. The mounting unit 600 may have legs 610, a base 1400 and a mounting frame 700. The mounting frame 700 is attachable to the bottom 20 as shown in FIG. 7. The frame 700 may have two sections, one per leg. FIG. 7 shows the mounting holes for the connecting means. The legs 610 extend between the mounting frame 700 and the base. The base is configured to be mounted to a target, such as a ground block for a wet well. FIG. 14 shows the example of the mounting unit 600 attached to the air treatment unit 1 and ground. FIG. 13 shows another example of a mounting unit 600A in accordance with aspects of the disclosure. In the mounting unit 600A illustrated in FIG. 13, the base is omitted, and the shape of the legs is different.

In other aspects, the air treatment unit 1 may be mounted using mounting brackets 2000 (two are shown in FIG. 20). The mounting brackets 2000 may be used to mount the air treatment unit 1 to a wall. Alternatively, the mounting brackets 2000 may be used to mount the air treatment unit 1 to unistruts. As shown in FIG. 20, the mounting brackets 2000 are located on the back wall of the air treatment unit 1 (two on the top). Additionally, there may be two mounting brackets located on the bottom of the air treatment unit 1. A portion of the mounting brackets 2000 extend beyond the top of the air treatment unit 1 to enable mounting (and bottom, for the bottom brackets). Each mounting bracket 2000 comprises openings. A fixing means may be inserted into the opening for mounting, e.g., bolt, to a wall or unistruts.

FIG. 7 illustrates certain dimensions for the bottom 20. These dimensions are shown only as examples for descriptive purposes. Other dimensions may be used.

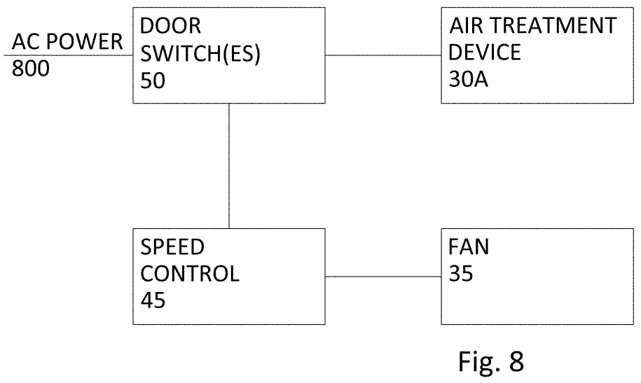

As noted above, power may be selectively supplied to certain electric components, such as at least the air treatment device 30A. FIG. 8 illustrates a block diagram of an example of a power path and control. Power may be received from an external power source. The power is AC power 800. The AC power 800 may be 120 VAC. Other voltages may be used. The AC power 800 may be electrically coupled to the door switch 50 (and where the access panel 605 is included in the unit, the door switch for the access panel 605) (such as via the terminal block 40 (or 40A in FIG. 20). When two door switches 50 are used (one for the door 10 and the other for the window in the access panel 605), the switches 50 are connected in series. The switches are also electrically connected to at least the air treatment device 30A (e.g., ionization device 30). When either door or window is open, the corresponding switch is opened. When either of the series switches is open, the AC power 800 is isolated from at least the air treatment device 30A (e.g., ionization device 30). When the switches 50 are not connected to the fan 35, either the door 10 or window of the access panel being open would have no effect on the operation of the fan 35. In other aspects of the disclosure, the switches 50 may be electrically connected with the air treatment device 30A (e.g., ionization device 30) and the fan 35 as shown in the power path in FIG. 8. Thus, opening the door or window would also shut off the fan 35.

The fan 35 may be connected in series with a fan control 45 (speed control). The fan control 45 may be manually set.

In an aspect of the disclosure, the intensity of the air treatment device 30A (e.g., ionization device 30) may be manually set during installation. For example, the ionization device 30 may be set to a maximum output. In aspects of the disclosure, the setting may be manually changed after installation.

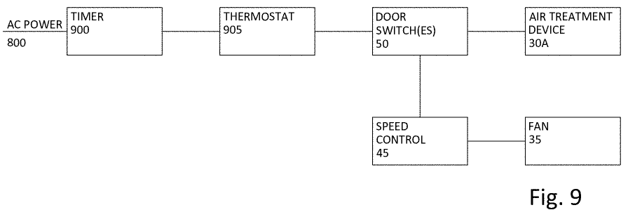

FIG. 9 illustrates a block diagram of another example of a power path and control. In the example illustrated in FIG. 9, two additional switching elements are added to the power path and control. A timer 900 and thermostat 905 are placed in series with the door switch(es) 50. The timer 900 is a programmable timer. In an aspect of the disclosure, the timer 900 may be manually programmed. The timer 900 may be set during installation. In other aspects of the disclosure, the timer 900 may be reprogrammed after installation, as needed.

The programmable timer includes a clock. The clock maintains a current time. The clock is used to determine whether the current time is within the programmed timing window. The timer 900 also includes a switch. The switch is a normally opened switch.

In an aspect of the disclosure, the timer 900 may be set to a timing window where high usage is expected. For example, for a wet well system that handles sewage, high usage may be expected in the morning. For example, a window from 6:00 AM to 10:00 AM may be set as a high usage time. When the timer 900 is set, the AC power 800 is only supplied to the air treatment device 30A (e.g., ionization device 30) and fan 35 during the timing window, e.g., closes the normally opened switch. Otherwise, the timer 900 causes the normally opened switch to open to isolate the power from the air treatment device 30A and fan 35. In other aspects of the disclosure, similar to the door switch 50, power may only be isolated from the air treatment device 30A (e.g., ionization device 30) and not the fan 35.

In other aspects of the disclosure, the timer 900 may be automatically programmed based on historical information. For example, the timer 900 may be an appliance timer, a mechanical timer or another type of programmable timer. For example, a wet well system may store data regarding temperature, pressure, usage, volatile organic compound (VOC) levels, flow rates, etc. A processor may analyze the data to determine a pattern of activity that indicates a need for air treatment at a certain time of day. For example, a truck may at a certain time of day deposit sewage. The processor would examine the schedule and automatically turn the system ON. In other aspects of the disclosure, the processor examines personal activity patterns, such as sleep schedule, eating schedule or other activities and correlates the activity to high usage of a wet well and automatically turns the system ON for the high usage period. In other aspects of the disclosure, the processor would examine industrial activities such as rendering and automatically turn the system ON when the activities appears to spike or increase.

Additionally, historical data for usage of the air treatment device may be stored and the time window set based on the historical data. In this aspect of the disclosure, the air treatment unit 1 may include an interface to a wet well system to receive system data. Additionally, the processor may be incorporated in the air treatment unit 1. In other aspects of the disclosure, the processor is external and in the wet well system where the timer 900 receives an instruction from the external processor and sets the timing window from the instruction.

In an aspect of the disclosure, the thermostat 905 is a line voltage thermostat which may be a commercially available off the shelf part. The line voltage thermostat comprises a temperature sensor, a switch and is programmed with a temperature threshold. The switch is normally closed. When the temperature sensor in the thermostat 905 detects an ambient temperature to be below the temperature threshold, the normally closed switch opens. Since the thermostat 905 is in series with the timer 900 and door switch 50, when any one of the switches are opened, power is isolated from at least the air treatment device 30A (e.g., ionization device 30). Power is capable of being supplied to the air treatment device 30A (e.g., ionization device 30) when all of the series switches (in timer 900, in thermostat 905 and door switches 50 are closed). In another aspect, both the fan 35 and the air treatment device 30A are shutoff.

In an aspect of the disclosure, the thermostat 905 prevents, the air treatment unit 1 from blowing cold air into the wet well causing water in the wet well to freeze and potentially crack the wet well. Therefore, in an aspect of the disclosure, the temperature threshold may be 32° F.

In an aspect of the disclosure, the thermostat 905 may be mounted adjacent to the filter grill 25 (mesh screen 1500) such that the thermostat 905 detects the ambient temperature. However, the thermostat 905 may be separated from the air treatment device 30A (e.g., ionization device 30) to prevent the thermostat 905 from detecting heat from the air treatment device 30A.

The remaining components of the power path and control are the same as in FIG. 8 and will not be described again in detail.

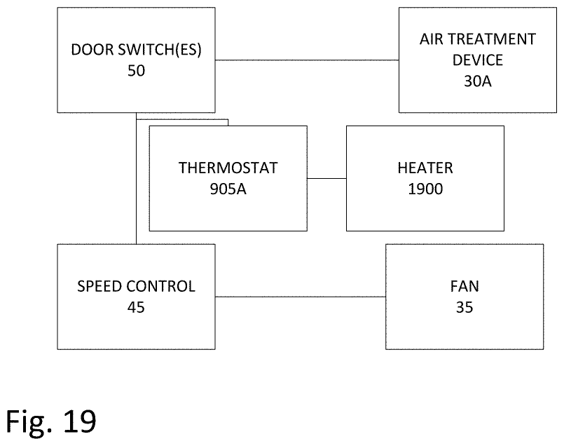

In another aspect of the disclosure, instead of shutting off at least the air treatment device 30A when the temperature is below a temperature threshold, the air treatment unit 1 may include a heater 1900. The heater 1900 may be connected in series with another line voltage thermostat 905A. This line voltage thermostat 905A may have a switch that is normally opened. When the temperature sensor in the thermostat detects an ambient temperature to be below the temperature threshold, the normally opened switch closes. The line voltage thermostat 905A may also be in series with the door switch 50 as shown in FIG. 19. Therefore, the heater 1900 may be turned on only when the door 10 is closed. In an aspect of the disclosure, the heater 1900 may be a resistive heating element. The resistive heating element may be disposed adjacent to the inlet of the fan such that air heated by the resistive heating element is blown into the duct 1308 (1308A) and wet well 1300. In an aspect of the disclosure, the heater 1900 may be run for a preset period of time and thereafter automatically be turned off. In accordance with this aspect, the power path may also include a timer set to the period of time. The timer may include a switch that is normally opened and closes when within the period of time.

In other aspects of the disclosure, the heater 1900 may operate only when the temperature is below the temperature threshold and once the air is heated to above the threshold, the heater 1900 is shut off. In other aspects of the disclosure, the temperature sensor may be located within the wet well 1300.

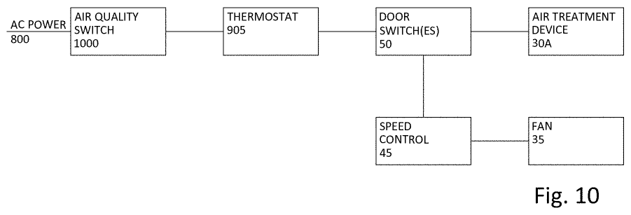

FIG. 10 illustrates a block diagram of another example of a power path and control. The power path and control illustrated in FIG. 10 is similar to that in FIG. 9, except that the timer 900 is replaced with an air quality switch 1000. The air quality switch 1000 may placed in series with the thermostat 905 and the door switch(es) 50.

The air quality switch 1000 may comprise a normally opened switch, an air quality sensor and a programmed threshold. The switch portion may be a relay (single pole and single or double throw). An air quality switch may also be referred to as “air monitoring system” “air relay system” or “transmitter” or “fixed gas detector”. The air quality switch may be an off the shelf device configured or programmed as needed. For example, an M2 ATM series transmitter sold by RKI Instruments may be used.

In other aspects of the disclosure, the air quality switch may include discrete components such as an air quality sensor and a separate processor, such as a programmable logic controller (PLC) and a relay or switch.

The air quality switch 1000 may be positioned in the wet well, before the filter 24 or after the filter 24. The threshold may be programmed manually during installation. In another aspect of the disclosure, the threshold may be changed after installation. The air quality sensor used may be application specific. For example, when the air treatment unit 1 is used to treat a wet well, the air quality sensor may be a hydrogen sulfide sensor. However, for other applications, other volatile organic compound sensors may be used. The sensor may indicate a parts-per billion or a percentage as a voltage or a current. The thresholds are correspondingly a voltage or current. In an aspect of the disclosure, the air quality switch 1000 may comprise a comparator that outputs a signal based on the comparison.

When the detected compound is higher than the threshold, the normally opened switch is configured to close, enabling the AC power 800 to be capable of being supplied to the air treatment device 30A (e.g., ionization device 30) and fan 35. When the detected compound is lower than the threshold, the normally open switch remains open.

Since the air quality switch 1000 is in series with the thermostat 905 and door switch 50, when any one of the switches are opened, power is isolated from the air treatment device 30A (e.g., ionization device 30) and the fan 35. Power is capable of being supplied to the air treatment device 30A (e.g., ionization device 30) when all of the series switches (air quality switch 1000, thermostat 905 and door switches) are closed.

To prevent the frequent cycling of the switch from closed to open and vice versa, the air quality switch 1000 may have another threshold. Once the normally opened switch is closed, the switch will not return to its normally opened state until the air quality sensor detects that the level of the compound is below the other threshold. The other threshold is less than the threshold. In an aspect of the disclosure, the thresholds are selected to be far enough apart to prevent short ON/OFF cycles.

The remaining components of the power path and control are the same as in FIG. 9 and will not be described again in detail.

In other aspects of the disclosure, similar to the other switches, power may only be isolated from the air treatment device 30A (e.g., ionization device 30) and not the fan 35.

When the air quality switch 1000 is within the housing 5, the switch 1000 may be used as a cutoff for the ionization device 30, e.g., when the sensor in the switch detects a compound, such as hydrogen sulfide above a threshold, the switch 1000 opens.

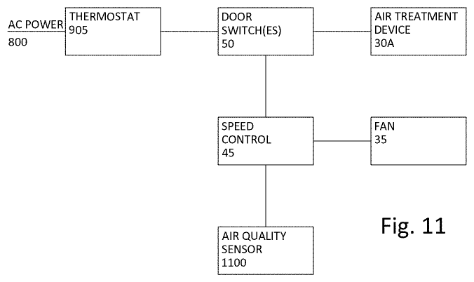

FIG. 11 illustrates a block diagram of another example of a power path and control. The power path and control illustrated in FIG. 11 is similar to that in FIG. 10 except that an air quality sensor 1100 replaces the air quality switch 1000. The air quality sensor 1100 controls the fan speed. The air quality sensor 1100 is electrically coupled to the fan control 45. The fan control 45 is automatically controlled based on the quality of the air. In the example depicted in FIG. 11, air quality is not controlled by OFF/ON AC power, but rather the amount of ions via the speed of the fan. As the speed of the fan increases, the ions capable of treating the air increase as ion recombination is reduced with increased airflow rate. Fan speed may be controlled by a sensor 1100 that is coupled to a processor that electronically increases or decreases fan speed based on the readings from the sensor 1100.

In accordance with this aspect of the disclosure, the air quality sensor 1100 may comprise a processor and memory storing a plurality of thresholds. The memory may also include a look up table (LUT) having a relationship between the thresholds and speed of the fan.

When the sensor detects the air quality, the processor compares the detection with the stored plurality of thresholds and looks up the related speed of the fan. In an aspect of the disclosure, the processor causes the speed control to automatically change the speed of the fan. For example, a programmable logic controller (PLC) may be used. Other processors may also be used.

For example, fixed gas detector (sensor 1100) may be coupled to the PLC to provide input signals (voltage or current). The fixed gas detector may be an off the shelf device such as available of PemTech, Inc.

The remaining components of the power path and control are the same as in FIG. 10 and will not be described again in detail.

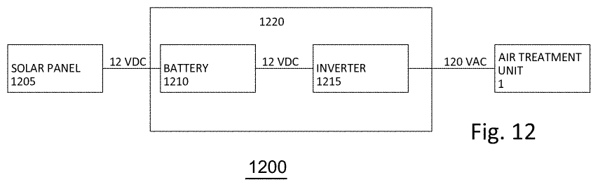

As described above, the air treatment unit 1 may be powered by an external power source. In an aspect of the disclosure, the external power source may be solar power. FIG. 12 illustrates a block diagram of an air treatment system 1200 using solar power.

The system 1200 comprises solar panel(s) 1205, a power unit 1220 and the air treatment unit 1. The solar panel(s) 1205 may be mounted directly to the air treatment unit 1. For example, the solar panel(s) 1205 may be mounted to the housing 5 (top of the body). The solar panels 1205 may be mounted to rotate to face the sun for a greater part of the day.

In an aspect of the disclosure, the solar panel(s) 1205 generate 12 VDC. The solar panel(s) 1205 are electrically coupled to the power unit 1220. The power unit 1220 comprises a battery 1210 and an inverter 1215. The battery 1210 and the inverter 1215 may be incorporated in a separate housing from the air treatment unit 1. For example, the housing for the power unit may be mounted adjacent to the air treatment unit 1. The housing may also be a NEMA type 4 electrical box. The battery 1210 is a rechargeable battery that has a voltage of at least 12 VDC.

The battery 1210 is electrically coupled to the inverter 1215. In an aspect of the disclosure, the inverter 1215 is configured to convert 12 VDC to 120 VAC. In other aspects of the disclosure, the inverter 1215 may be configured to convert the 12 VDC to 240 VAC.

The inverter 1215 is electrically coupled to the air treatment unit 1. When a terminal block 40 (or terminal block 40A as shown in FIG. 20) is used, the inverter 1215 is connected to the terminal block 40 (or terminal block 40A as shown in FIG. 20) via wires.

The system 1200 may use any of the above described power paths and controls for limiting the ON time of the fan and/or air treatment device 30A (e.g., ionization device 30) or speed of the fan 35 to conserve power or achieve optimum air quality.

For example, where the timer 900 is used and the fan 35 and air treatment device 30A is only ON when the current time is within the timing window, when the window closes, e.g., current time is after the timing window, the solar panel(s) 1205 may recharge the battery 1210 for subsequent use. Also, when the timing window coincides with a sunny day or daytime, the solar panel(s) 1205 may charge the battery 1210 as the power is being delivered. This may maintain a high state of charge (SOC) on the battery 1210.

In other aspects of the disclosure, a plurality of batteries 1210 may be connected to the solar panel(s) 1205. When the SOC of one of the batteries is recharged to a target SOC, another battery may then be recharged. In other aspects, the batteries may also be connected to the solar panel(s) 1205 so that they all charge (or discharge) simultaneously.

In other aspects of the disclosure, the system 1200 may also comprise a processor (not shown). The processor may control the supply of power to the fan 35 and air treatment device 30A (e.g., ionization device 30) and/or the speed and intensity of the air treatment device 30A (e.g., ionization device 30) based on an SOC of the battery 1210.

In this aspect of the disclosure, a preset SOC threshold may be stored. The processor compares the current SOC of the battery 1210 with the preset SOC threshold. When the current SOC is at the preset SOC threshold, the processor may lower the fan speed and/or the intensity of the air treatment device 30A to a minimum speed and/or intensity to conserve power.

Another preset SOC threshold may be used to shut OFF the fan 35 and air treatment device 30A (e.g., ionization device 30). The another preset SOC threshold is less than the preset SOC threshold. The another preset SOC threshold may be set to a minimum SOC level for maintaining a good life of the battery 1210.

The system 1200 with the air treatment unit 1 may be used to treat airflow within a wet well. FIG. 16 illustrates an example of a system for treating airflow within a wet well 1300 in accordance with aspects of the disclosure. The air treatment unit 1 as depicted in FIG. 16 does not include the optional access panel. The system has a backdraft damper 1600 installed in-line with duct 1308A and duct collar 60. The backdraft damper 1600 is between the air treatment unit 1 and the wet wall 1300. The backdraft damper 1600 may comprise a single circular blade that rotates. When the fan 35 is not blowing, the blade is orthogonal to the airflow path and thus is in a closed position. In a closed position, the blade blocks the flow of air from the wet well 1300 into the air treatment unit 1. However, when the fan 35 is blowing, the blade rotates about a shaft under the force of the airflow from the fan and the blade moves to an open position. In the opened position, the blade allows the flow of air from the air treatment unit 1 toward the wet well 1300. In other aspects, the damper 1600 may comprise multiple blades which open/close when the fan 35 is on (open) or off (closed). Advantageously, the use of a damper 1600 prevents compounds from entering into the air treatment unit 1 when the fan 35 is not on. For example, the blade acts as a barrier for hydrogen sulfide (and other compounds).

The backdraft damper 1600 is positioned downstream of the duct collar 60. Thus, one end of the damper 1600 is connected to the collar 60 (the collar includes a length of duct) and the other end is connected to the duct 1308A. The connections are shown in the figure with double lines. The backdraft damper 1600 may have the same diameter as the duct collar 60 and the duct 1308A. For example, the diameter may be 8 inches. However, other diameters may be used. The air treatment unit 1 may be mounted to the ground via a mounting unit, e.g., unit 600A, as shown in FIG. 16. However, other mounting options may be used. There is a space between the ground and the bottom 20 of the air treatment unit 1. The air flows into the air treatment unit 1 via the opening (air inlet), as shown in the figures with an arrow.

In other aspects of the disclosure, the air treatment unit 1 may be wall mounted via a mounting plate or brackets. For example, the mounting plate may be connected to the back wall of the unit 1 (opposite side of the door 10). When the air treatment unit 1 is wall mounted, the unit 1 should be mounted at a sufficient height to allow airflow under the unit and into the air inlet (via e.g., the stainless steel mesh screen 1500).

The duct 1308A is connected to the wet well 1300. Treated air moves from the air treatment unit 1, through the duct collar 60, backdraft damper 1600 and duct 1308A into the wet well 1300. The wet well 1300 has a vent 1305. Clean (treated) air comes out of the vent 1305.

FIG. 17 illustrates another example of a system for treating airflow within a wet well 1300 in accordance with aspects of the disclosure. The system depicted in FIG. 17 is similar to the system in FIG. 16 except that the backdraft damper 1600A is controlled by an actuator 1700. The actuator 1700 controls the rotation of the blade around the shaft, e.g., motorized movement between closed position and opened position. The actuator 1700 is mechanically connected to the shaft of the damper. The actuator 1700 is electrically connected with the air treatment unit 1 via cable 1705. Since the actuator 1700 is external to the air treatment unit 1, the actuator 1700 may be also contained in a NEMA 4X box. The cable 1705 enters the air treatment unit 1 via an opening in the housing. The opening may be weather shield. The opening is slightly larger than the cable 1705 to allow the cable to enter, but not too large to allow water to enter. The cable 1705 may be connected with the power supply. In some aspects, the cable 1705 is connected to the power supply via a resistor. This acts as a control signal to open the blade (when power is on) and close the blade (when power is off).

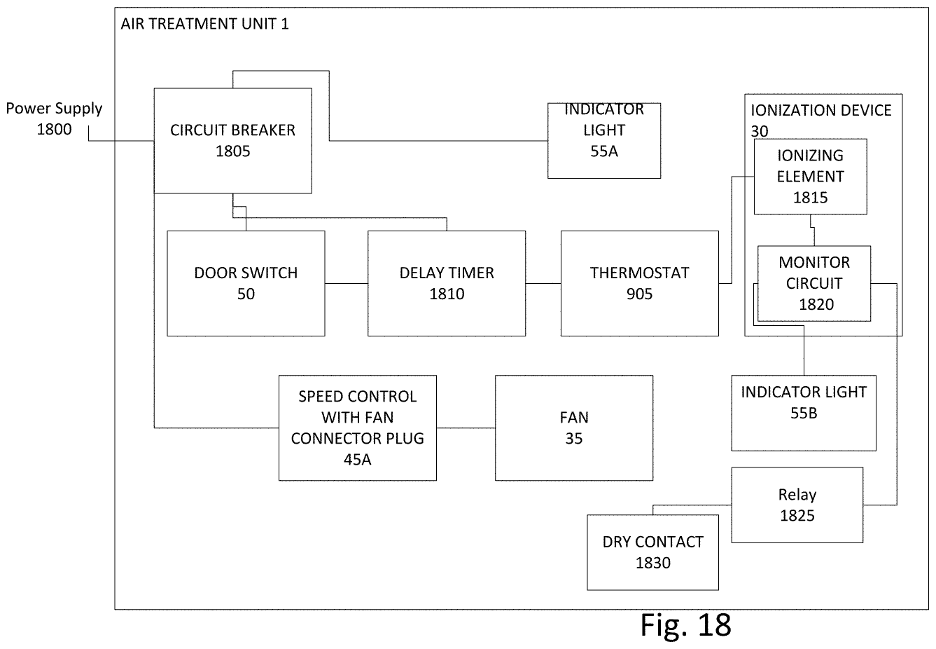

FIG. 18 depicts a block diagram of another example of an air treatment unit 1 in accordance with aspects of the disclosure. In some aspects of the disclosure, the power supply 1800 is external to the air treatment unit 1. The power supply is an AC power supply and may include the solar power system 1205/1220 depicted in FIG. 12. However, other AC power supplies may be used including grid power. The power supply is connected to a circuit breaker 1805 (for example via a terminal block 40A as shown in FIG. 20). The terminal block 40A is not shown in FIG. 18. The circuit breaker 1805 may be a 1 pole breaker. The circuit breaker 1805 acts as ON/OFF switch. As shown in FIG. 20, the circuit breaker 1805 is electrically connected to terminal block 40A, the circuit breaker 1805 may be mounted near the terminal block 40A. When the connection is maintained (not broken by the breaker), the indicator light 55A emits light. The AC power is supplied to the light indicator 55A. The circuit breaker 1805 may be manually moved to a connected state during installation.

As depicted in FIG. 18, the fan 35 is electrically connected with a speed control with a connector plug 45A. The connector plug is grounded. The connector plug is a female. The male plug on the fan may be connected to the female connector plug in element 45A. The speed control functions as described above. When the connection is maintained (not broken by the breaker), the speed control 45A is supplied with the AC power. In accordance with aspects of the disclosure, when the air treatment unit 1 is ON, the fan 35 is running.

In some aspects, the air treatment unit 1 may also include a resistor (not shown in FIG. 18). This resistor may be electrically coupled to the actuator 1700 and cause the actuator 1700 to open the damper 1600A, e.g., motorized opening of the actuator. Thus, when the fan 35 is on, damper 1600A is controlled to be open. The resistor is energized to open the damper 1600A and deenergized to close the damper 1600A (when the fan 35 is off).

The air treatment unit 1 may also include a delay timer 1810. The delay timer 1810 is positioned such that the ionization device 30 (air treatment device 30A) is activated after the fan 35 is running. As shown in the example, of the air treatment unit depicted in FIG. 20, the delay timer 1810 is connected by at least one cable to the door switch 50 and also to the terminal block 40A. The delay timer 1810 may be mounted near the terminal block 40A. As depicted in FIG. 20, the delay timer 1810 is between the circuit breaker 1805 and the terminal block 40A. By using a delay timer 1810, build up of ions within the air treatment unit 1 is prevented. Moreover, if any pollutant is within the air treatment unit 1, running the fan prior to turning on the ionization device 30 will allow the pollutant to be blown out of the air treatment unit 1 before the ionization device 30 is turned on. For example, hydrogen sulfide is flammable or explosive in sufficiently high concentrations. If the ionization device 30 is turned on when there is hydrogen sulfide in the air treatment unit 1, there is a chance of a combustion or explosion event. The fan 35 may run for a period of time prior to the ionization device 30 receiving power. The delay timer 1810 may be connected in series with the door switch 50. Therefore, even if the door 10 is closed, the ionization device 30 is not powered until the delay expires. Once both the door 10 is closed and the time period exceeds the delay time, the ionization device 30 may be powered.

In other aspects of the disclosure, when both the fan 35 and ionization device 30 does not receive power until the door 10 is closed, the delay timer 1810 may start the delay once the door 10 is closed.

FIG. 18 depicts a line voltage thermostat 905. However, as described above, the thermostat 905 is optional. The ionization element 1815 within the ionization device 30 receives the AC power. For example, a cable having three wires may be connected to the ionization element 1815, high, low and ground. In an aspect of the disclosure, the high may be supplied via the thermostat 905, delay timer 1810 and door switch 50. The ionization device 30 may include a monitor circuit 1820. The monitor circuit 1820 monitors the operation of the ionization element 1815. The monitor circuit 1820 may include a relay. When the ionization element 1815 is on and running, the relay closes and the indicator light 55B receives the AC power and emits a light, otherwise, the relay is open.

Another relay 1825 may be connected in parallel with the indicator light 55B. This relay 1825 may be electrically connected in series with a dry contact 1830. In an aspect of the disclosure, the dry contact 1830 may be included in the ionization device 30. For example, the dry contact 1830 may be mounted to a front surface of the ionization device 30 and connected to a Building Automation System (BAS) (not shown in the figure) which is also known as a Building Management System (BMS). A connection cable may be inserted into the dry contact 1830. When the relay 1825 is closed, the BAS receives power via the dry contact 1830. Therefore, an operator at the BAS will know that the ionization element 1815 is on and producing ions. However, when the relay 1825 is open, the BAS will not receive anything. Therefore, the operator at the BAS will know that the ionization element 1815 is off. This may be indicative of a malfunction. The dry contact 1830 may be connected in other manners to the unit 1 such that the operation of the ionization device 30 is known to a BAS.

In other aspects of the disclosure, the dry contact 1830 may be separate from the ionization device 30. The housing 5 may have an opening for the cable between the dry contact 1830 and the BAS. The opening may be weather shielded.

The air treatment unit 1 is grounded, e.g., ground 2010. The grounding may include a cable connected to the housing 5.

The air treatment unit 1 may also include a document holder 2005 as shown in FIG. 20. The document holder 2005 may include a slot for documents such as manuals. The document holder 2005 may be mounted to the inside of the door (interior).

The air treatment unit 1 may also include a sub-panel 2020. The sub-panel 2020 may be attached to housing 5 (back wall) as shown in FIG. 20. The sub-panel 2020 may be used to attached certain components of the system instead of being directly attached to the housing 5 which would require additional openings in the housing 5. The sub-panel 2020 is attached to the interior surface. In some aspects, the interior surface of the housing may be exposed, e.g., exposed housing 2025 (as shown in FIG. 20).

FIGS. 13-15 illustrate other examples of configurations for mounting the air treatment unit 1 and attaching to the wet well 1300. For example, in FIGS. 13-15 the backdraft damper 1600/1600A are not used. Additionally, the air treatment unit 1 has an access panel 605.

As shown in FIGS. 13 and 14, the air treatment unit 1 is mounted to the ground via different mounting units, e.g., 600A (FIG. 13) and 600 (FIG. 14).

While FIGS. 13-15 show the access panel 605 on the side, the access panel 605 may be located in other places. Additionally, the power unit 1220 and solar panel(s) 1205 are not shown in FIGS. 13-17. However, these features may be included.

The air treatment unit 1 depicted in FIG. 15 has the same stainless steel mesh screen 1500 as the units in FIGS. 16 and 17.

A processor described herein may be a microcontroller or microprocessor or any other processing hardware such as a CPU or GPU, an ASIC, FPGA or a PLA and the like.

Various aspects of the present disclosure may be embodied as a program, software, or computer instructions embodied or stored in a computer or machine usable or readable medium, or a group of media which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided, e.g., a computer program product.

The terminology used herein is for the purpose of describing particular embodiments only and is not intended to be limiting the scope of the disclosure and is not intended to be exhaustive. Many modifications and variations will be apparent to those of ordinary skill in the art without departing from the scope and spirit of the disclosure.

What is claimed is:

1. An air treatment system for a wet well comprising:
a water-resistant housing comprising a door and a body, the body having walls forming a compartment, the door being movable relative to the body to cover the compartment when closed and expose the compartment when open,
the body having an inlet opening in a bottom wall, the inlet opening being an air inlet, where the inlet opening is at least partially covered by a screen or a filter, the body further having an outlet opening in a wall of the body orthogonal to the bottom wall, the outlet opening being an air outlet,
the system further comprising:
an ionization device configured to generate bi-polar ions, the ionization device being disposed within the compartment in air communication with the inlet opening; and
a centrifugal fan being disposed within the compartment, the centrifugal fan having an air outlet, the air outlet of the centrifugal fan being mounted to the wall of the body orthogonal to the bottom wall, where the air outlet of the centrifugal fan is aligned with the outlet opening in the wall,
wherein power is supplied from an external power source, and
wherein the power is selectively connected to at least the ionization device based on at least one criterion.

2. The air treatment system for a wet well according to claim 1, further comprising a duct collar, the duct collar being mounted to the wall of the body orthogonal to the bottom wall and aligned with the outlet opening in the wall and the air outlet of the centrifugal fan.

3. The air treatment system for a wet well according to claim 2, wherein the duct collar is dimensioned to receive an air duct, the air duct being couplable to the wet well, the system further comprising a backdraft damper in-line with the air duct and positioned between the duct collar and the wet well.

4. The air treatment system for a wet well according to claim 3, further comprising an actuator connected to the backdraft damper, the actuator configured to control the backdraft damper to close to block airflow when the air treatment system is not running or open to allow airflow.

5. The air treatment system for a wet well according to claim 1, further comprising a door switch, the door switch being mounted on a wall of the body and positioned to contact the door when the door is closed, wherein the criterion is a state of the door switch, wherein when the door switch indicates that the door is closed, power is connected, and wherein when the door switch indicates that the door is opened, power is isolated.

6. The air treatment system for a wet well according to claim 1, further comprising a speed control device, the speed control device being electrically coupled to the centrifugal fan, the speed control device configured to control the speed of the fan.

7. The air treatment system for a wet well according to claim 1, further comprising at least two indicator lights electrically coupled to the power, wherein the at least two indicator lights are mounted on the door and viewable externally via respective openings in the door.

8. The air treatment system for a wet well according to claim 7, wherein one of the at least two indicator lights indicates a state of the ionization device, wherein the system further comprises a dry contact, the dry contact capable of being connected with a building automation system (BAS) and indicating the state of the ionization device.

9. The air treatment system for a wet well according to claim 1, further comprising a line voltage thermostat electrically coupled to the power, wherein the criterion is a temperature, and wherein when an ambient temperature is below a preset temperature threshold, the line voltage thermostat isolates the power from the ionization device and the centrifugal fan.

10. The air treatment system for a wet well according to claim 9, wherein the preset temperature threshold is 32° F.

11. The air treatment system for a wet well according to claim 1, further comprising a mounting unit, the mounting unit is couplable to the bottom wall or a wall orthogonal from the bottom wall, the mounting unit is configured to mount the water-resistant housing proximate to the wet well and maintain a space between the bottom wall and ground, the mount has a base with legs, the legs being attached to the ground.

12. The air treatment system for a wet well according to claim 1, further comprising a programmable timer electrically connected to the power, the programmable timer is configured to be set to a timing window, wherein the criterion is a timing and wherein the power is connected to the centrifugal fan and the ionization device when a current time is within the timing window and isolated when the current time is outside the timing window.

13. The air treatment system for a wet well according to claim 1, further comprising a hydrogen sulfide sensor electrically connected to the power, the hydrogen sulfide sensor having a sensed threshold, wherein the criterion is air quality, and wherein when the hydrogen sulfide sensor detects hydrogen sulfide above the sensed threshold, the power is connected to at least the ionization device.

14. The air treatment system for a wet well according to claim 13, wherein when the hydrogen sulfide sensor detects hydrogen sulfide below a second sensed threshold after detecting the hydrogen sulfide above the sensed threshold, the power is isolated from at least the ionization device.

15. The air treatment system for a wet well according to claim 1, wherein an amount of ions produced by the ionization device is controllable via a switch.

16. The air treatments for a wet well according to claim 6, wherein the speed of the centrifugal fan is controlled based on an air quality sensor.

17. The air treatment system for a wet well according to claim 1, further comprising a solar panel, a rechargeable battery and an inverter, wherein the battery and the inverter is housed within an additional housing and wherein the solar panel is electrically connected to the rechargeable battery, and wherein the solar panel is configured to charge the rechargeable battery.

18. The air treatment system for a wet well according to claim 1, further comprising a delay timer configured to delay turning on the ionization device with respect to turning on the centrifugal fan.

19. The air treatment system for a wet well according to claim 1, further comprising a line voltage thermostat electrically coupled to the power; and a heater electrically coupled to the line voltage thermostat, wherein when an ambient temperature is below a preset temperature threshold, the line voltage thermostat causes power to be supplied to the heater and when the temperature is above the preset temperature threshold, the line voltage thermostat isolates the power from heater.

20. An apparatus comprising:
a water-resistant housing comprising a door and a body, the body having walls forming a compartment, the door being movable relative to the body to cover the compartment when closed and expose the compartment when open, the body having an inlet opening in a bottom wall, the inlet opening being an air inlet, where the inlet opening is at least partially covered by a screen or a filter, the body further having an outlet opening in a wall of the body orthogonal to the bottom wall, the outlet opening being an air outlet,
the apparatus further comprising:
an ionization device configured to generate bi-polar ions, the ionization device being disposed within the compartment in air communication with the inlet opening; and
a centrifugal fan being disposed within the compartment, the centrifugal fan having an air outlet, the air outlet of the centrifugal fan being mounted to the wall of the body orthogonal to the bottom wall, where the air outlet of the centrifugal fan is aligned with the outlet opening in the wall,
wherein power is supplied from an external power source via a wire opening in the body, and
wherein the power is selectively connected to the ionization device and the centrifugal fan.

21. An apparatus comprising:
a water-resistant housing comprising a door and a body, the body having walls forming a compartment, the door being movable relative to the body to cover the compartment when closed and expose the compartment when open, the body having an inlet opening in a bottom wall, the inlet opening being an air inlet, where the inlet opening is at least partially covered by a screen or a filter, the body further having an outlet opening in a wall of the body orthogonal to the bottom wall, the outlet opening being an air outlet,
the apparatus further comprising:
an ionization device configured to generate bi-polar ions, the ionization device being disposed within the compartment in air communication with the inlet opening; and
a fan being disposed within the compartment, the fan having an air outlet, the air outlet of the fan being mounted to the wall of the body orthogonal to the bottom wall, where the air outlet of the fan is aligned with the outlet opening in the wall,
wherein power is supplied from an external power source, and
wherein the power is selectively connected to at least the ionization device based on a criterion.
